(19) United States
(12) Patent Application Publication
(10) Pub. No.: US 2026/0093995 A1
(43) Pub. Date: Apr. 2, 2026

(54) DIFFERENTIALLY PRIVATE STOCHASTIC GRADIENT DESCENT USING OPTIMIZED CORRELATION MATRICES

(71) Applicant: GDM Holding LLC, Mountain View, CA (US)

(72) Inventors: Christopher Choquette Choo, Sunnyvale, CA (US); Arun Ganesh, Seattle, WA (US); Abhradeep Guha Thakurta, Los Gatos, CA (US); Thomas Alexander Steinke, Menlo Park, CA (US); Saminul Haque, Stanford, CA (US)

(21) Appl. No.: 19/343,725

(22) Filed: Sep. 29, 2025

Related U.S. Application Data
(60) Provisional application No. 63/702,120, filed on Oct. 1, 2024.

(51) Int. Cl. G06N 3/09; G06N 3/047

(52) U.S. Cl. CPC G06N 3/09; G06N 3/047

(57) ABSTRACT

Methods, systems, and apparatuses, including computer programs encoded on computer storage media, for training a neural network using differentially private stochastic gradient descent (DP-SGD) with correlated noise. In some implementations, a system determines a correlation matrix by performing an optimization to improve a utility metric that is dependent on a noise multiplier. The system can then train the neural network using the optimized correlation matrix and a privacy-amplifying batching scheme to produce a neural network with high utility while satisfying a data security criterion.

### CROSS-REFERENCE TO RELATED APPLICATIONS

This application claims priority of U.S. Provisional Application No. 63/702,120 filed Oct. 1, 2024. The content of the prior application is incorporated herein by reference in its entirety.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that trains a neural network using differentially private stochastic gradient descent (DP-SGD). That is, the system performs updates of the neural network parameters while ensuring strong data security by using differentially private updates.

The subject matter described in this specification can be implemented in particular embodiments so as to realize one or more of the following advantages.

Differentially Private Stochastic Gradient Descent (DP-SGD) is an adaptation of the traditional Stochastic Gradient Descent (SGD) algorithm that integrates differential privacy mechanisms into the training process. In DP-SGD, noise is systematically added to the gradients computed during each training iteration to bound the sensitivity of the neural network model to any individual training example. The noise can be calibrated to achieve a predefined data security criterion, e.g., expressed in terms of the (ϵ,δ)-differential privacy framework, e.g., in order to increase the likelihood that network outputs generated by the neural network are nearly indistinguishable, regardless of whether any single training example is included in the training data.

A key technical benefit of DP-SGD is its ability to protect individual training examples in the training data while still producing a trained neural network with a high level of utility, e.g., prediction accuracy. By integrating differential privacy into SGD, DP-SGD allows neural networks to be trained on datasets while minimizing the risk of exposing individual training examples through network outputs.

Training a neural network using DP-SGD involves a privacy-utility tradeoff based on a balance between adding sufficient noise to protect data privacy and maintaining the prediction accuracy of the neural network, where increasing privacy (through larger noise) can reduce prediction accuracy, while reducing noise improves prediction accuracy but weakens privacy protection.

One approach for improving the privacy-utility tradeoff when training a neural network using DP-SGD is to use a correlated noise technique in which noise values added to the gradients across multiple training iterations are interdependent (correlated) rather than independent. This is achieved by structuring the noise so that noise added in one training iteration is partially canceled out in subsequent training iterations. Introducing correlated noise can maintain privacy while reducing the accumulation of noise, thereby improving the prediction accuracy of the neural network.

The correlated noise technique can be implemented by, at each training iteration, modifying the initial noise values that are sampled from a noise distribution using a correlation matrix. The choice of correlation matrix is a tradeoff between the “noise multiplier” (which controls the magnitude of the noise added to the gradients) needed to satisfy the data security criterion and the benefits of noise cancelation. As extreme examples: (i) setting the correlation matrix equal to an identity matrix requires a minimum noise multiplier but offers no noise cancelation, and (ii) setting the correlation matrix as an all-ones lower triangular matrix may cancel out a significant part of the noise added in one training iteration at the next training iteration but requires a large noise multiplier.

The system described in this specification trains a neural network using DP-SGD with correlated noise. The system determines the correlation matrix used to implement the correlated noise technique by performing a numerical optimization to optimize the correlation matrix with reference to a utility metric. More specifically, the system can optimize the correlation matrix using gradients of the utility metric with respect to the correlation matrix, e.g., by a gradient descent optimization technique. During optimization of the correlation matrix, the utility metric used to evaluate the correlation matrix depends (at least in part) on a corresponding noise multiplier. The system selects the noise multiplier used in computation of the utility metric so that training the neural network using the correlation matrix in conjunction with the noise multiplier is predicted to cause the neural network to satisfy a target data security criterion. The system can thus optimize the correlation matrix subject a constraint that the correlation matrix enables the target data security criterion to be satisfied.

Performing DP-SGD with correlated noise that is implemented using an optimized correlation matrix can enable a reduction in consumption of computational resources (e.g., memory and computing power) during training by reducing the amount of training data and the number of training iterations required for the neural network to achieve a threshold prediction accuracy while satisfying a data security criterion.

The utility metric of a correlation matrix may be based (at least in part) on the noise multiplier, i.e., that is used in conjunction with the correlation matrix during training. Optimizing the correlation matrix with reference to the utility metric by gradient descent can therefore require determining gradients of the noise multiplier with respect to the correlation matrix. However, determining gradients of the noise multiplier with respect to the correlation matrix may be challenging because of the lack of a closed form expression for the noise multiplier as a function of the correlation matrix, particularly when privacy amplification is used as part of the training procedure. (Privacy amplification uses randomness in the process for selecting batches of training data for training the neural network in order to improve the privacy performance of the trained neural network).

The system can address this issue by determining the noise multiplier as a function of the correlation matrix using a δ-estimation function that generates a Monte Carlo estimate of the privacy breach parameter δ associated with a correlation matrix. The δ-estimation function is differentiable with respect to the correlation matrix and therefore enables computation of gradients of the noise multiplier with respect to the correlation matrix by auto-differentiation during optimization of the correlation matrix. The δ-estimation function that generates the Monte Carlo estimate of the privacy breach parameter δ thus enables reduced consumption of computational resources (e.g., memory and computing power) during training by facilitating optimization of the correlation matrix.

The dimensionality of the correlation matrix can be proportional to the number of parameters in the neural network. The number of parameters in the neural network can be very large, e.g., on the order of millions or billions, which can cause the dimensionality of the correlation matrix to be very large. Optimizing a high-dimensional correlation matrix can be challenging, e.g., because of an increased risk of the optimization failing to converge, or converging upon undesirable local minima. To address this issue, the system can optimize the correlation matrix subject to a constraint that the correlation matrix belong to a lower-dimensional subspace of the space of possible correlation matrices. The lower-dimensional subspace can be, e.g., the space of Toeplitz matrices or the space of block lower triangular matrices or the space of Buffered Linear Toeplize matrices (as described in arXiv:2404.16706). The system can thus reduce the number of effective parameters of the correlation matrix to be optimized, which can reduce the likelihood of the optimization converging upon undesirable local minima and also drastically reduce consumption of computational resources (e.g., memory and computing power) during the optimization.

In summary, the system described in this specification trains a neural network with DP-SGD with correlated noise implemented using a correlation matrix that is optimized in relation to a utility metric. The system optimizes the correlation matrix to cause the trained neural network to satisfy a target data security criterion, and thus enhances data security in relation to the underlying set of training data used for training the neural network. The system optimizes the correlation matrix in relation to a utility metric allows the selection of a correlation matrix that achieves a beneficial tradeoff between the scale of the noise multiplier and the benefits of noise cancelation. The system thus enables reduced consumption of computational resources during training, e.g., by reducing the amount of training data and/or the number of training iterations required to enable the neural network to achieve an acceptable prediction accuracy (while maintaining data security of the training data).

The details of one or more embodiments of the subject matter of this specification are set forth in the accompanying drawings and the description below.

According to a first aspect there is provided a method performed by one or more computers for training of a neural network, the method comprising: training the neural network on a set of training examples to perform a machine learning task, the training comprising, at each of a plurality of training iterations: determining gradients of an objective function with respect to a set of neural network parameters of the neural network; generating a plurality of noise values for modifying the gradients of the objective function, comprising: stochastically sampling a plurality of initial noise values from a noise distribution that is parametrized by a noise multiplier; and generating the noise values by applying a correlation matrix to the plurality of initial noise values; generating noisy gradients by combining the plurality of noise values with the gradients of the objective function; and updating the set of neural network parameters of the neural network using the noisy gradients; wherein the correlation matrix used during the training of the neural network is determined by performing operations comprising: iteratively updating a current correlation matrix over a plurality of optimization iterations to optimize a utility metric, comprising, at each optimization iteration: determining a current noise multiplier that, if used in conjunction with the current correlation matrix during the training of the neural network, is predicted to cause the trained neural network to satisfy a data security criterion; determining a current utility metric for the current correlation matrix based at least in part on the current noise multiplier; determining gradients of the current utility metric with respect to the current correlation matrix; and updating the current correlation matrix using the gradients of the current utility metric.

In some cases, the data security criterion is an (ϵ, δ)-differential privacy (DP) criterion, ϵ is a target privacy budget parameter defining a bound on a privacy loss, and δ is a target privacy breach parameter defining a bound on a probability of a privacy loss exceeding the privacy budget parameter ϵ.

In some cases, determining a current noise multiplier that, if used in conjunction with the current correlation matrix during the training of the neural network, is predicted to cause the trained neural network to satisfy the data security criterion comprises: determining the current noise multiplier using a δ-estimation function that is configured to process an input correlation matrix, an input noise multiplier, and an input privacy budget parameter to generate a Monte Carlo estimate of a corresponding privacy breach parameter.

In some cases, the δ-estimation function is configured to generate the Monte Carlo estimate of the corresponding privacy breach parameter as an average of a plurality of stochastic estimates of the privacy breach parameter, each of the plurality of stochastic estimates of the privacy breach parameter is based at least in part on one or more random values that are sampled from one or more probability distributions, the plurality of stochastic estimates of the privacy breach parameter are generated substantially in parallel.

In some cases, determining the current noise multiplier using a δ-estimation function comprises selecting the current noise multiplier so that processing the current correlation matrix, the current noise multiplier, and a target privacy budget parameter ϵ using the δ-estimation function causes the δ-estimation function to generate an estimated privacy breach parameter that is within a tolerance threshold of a target privacy breach parameter δ.

In some cases, the current noise multiplier is selected using a bisection algorithm.

In some implementations, determining the current utility metric for the current correlation matrix based at least in part on the current noise multiplier comprises: determining the current utility metric for the current correlation matrix as:

$$σ \cdot \vert {A}^{- 1} C \vert$$

where σ is the current noise multiplier, A is an all-ones lower-triangular matrix, C is the current correlation matrix, and |·| is a norm operation.

In some cases, determining gradients of the current utility metric with respect to the current correlation matrix comprises: determining gradients, with respect to the current correlation matrix, of a δ-estimation function that is configured to process an input correlation matrix, an input noise multiplier, and an input privacy budget parameter to generate a Monte Carlo estimate of a corresponding privacy breach parameter; and determining the gradients of the current utility metric based at least in part on the gradients of the δ-estimation function.

In some cases, determining gradients of the current utility metric with respect to the current correlation matrix comprises: determining gradients, with respect to the current noise multiplier, of a δ-estimation function that is configured to process an input correlation matrix, an input noise multiplier, and an input privacy budget parameter to generate a Monte Carlo estimate of a corresponding privacy breach parameter; and determining the gradients of the current utility metric based at least in part on the gradients of the δ-estimation function.

In some cases, determining gradients of the current utility metric with respect to the current correlation matrix comprises: determining the gradients of the current utility metric as:

$$σ \cdot \frac{\partial \vert {A}^{- 1} C \vert}{\partial C} - \frac{\vert {A}^{- 1} C \vert ( \frac{\partial \hat{δ}}{\partial C} )}{\frac{\partial \hat{δ}}{\partial σ}}$$

where σ is the current noise multiplier, A is an all-ones lower-triangular matrix, C is the current correlation matrix, |·| is a norm operation, ∝ is a partial derivative operator, and \hat{δ} is a δ-estimation function.

In some cases, during the iterative updates to the current correlation matrix over the plurality of optimization iterations, the current correlation matrix is constrained to remain in a lower-dimensional subspace of a space of possible correlation matrices.

In some cases, the lower-dimensional subspace comprises a space of Toeplitz matrices.

In some implementations, the lower-dimensional subspace comprises a space of block lower triangular matrices.

In some cases, the lower-dimensional subspace comprises a space of lower triangular matrices.

In some cases, updating the current correlation matrix using the gradients of the current utility metric comprises: updating the current correlation matrix using the gradients of the current utility metric using a gradient descent optimization technique.

According to a second aspect there is provided a method performed by one or more computers, the method comprising: obtaining a set of training examples; partitioning the set of training examples into a plurality of batches, comprising: shuffling the set of training examples; sampling a batch size schedule; and selecting the batches from the shuffled set of training examples in accordance with the batch size schedule; and training a neural network on a respective batch of training examples at each of a plurality of training iterations.

In some cases of the second aspect, the method further comprises, in response to determining that a batch includes more than a threshold number of training examples, truncating the batch to have the threshold number of training examples.

In some cases of the second aspect, the method further comprises, in response to determining that a batch includes less than a threshold number of training examples, padding the batch to have the threshold number of training examples; where padding the batch comprises adding dummy training examples into the batch, where each dummy training example is associated with zero gradients.

In some cases of the first or second aspect, the neural network is configured to perform an image processing task comprising processing an input image to generate a prediction characterizing the input image; or the neural network is configured to perform an audio processing task comprising processing input audio data to generate a prediction characterizing the input audio data; or the neural network is configured to perform a video processing task comprising processing input video data to generate a prediction characterizing the input video data.

In some cases of the first or second aspect, the method further comprises, after training the neural network: receiving a network input to the neural network; and processing the network input using the trained neural network to generate a corresponding network output; and providing the network output generated by the neural network.

According to a third aspect there is provided a method performed by one or more computers, the method comprising: transmitting, from a server and to a remotely located user device, data defining: (i) current values of a set of neural network parameters of the neural network, and (ii) a correlation matrix; where the correlation matrix is determined by performing operations comprising: iteratively updating a current correlation matrix over a plurality of optimization iterations to optimize a utility metric, comprising, at each optimization iteration: determining a current noise multiplier that, if used in conjunction with the current correlation matrix during training of the neural network by differentially private stochastic gradient descent (DP-SGD), is predicted to cause the trained neural network to satisfy a data security criterion; determining a current utility metric for the current correlation matrix based at least in part on the current noise multiplier; determining gradients of the current utility metric with respect to the current correlation matrix; and updating the current correlation matrix using the gradients of the current utility metric; obtaining, by the server and from the remotely located user device, noisy gradients generated by performing DP-SGD on the set of neural network parameters of the neural network at the remotely located user device and based on training data that is stored locally on the remotely located user device; and updating, by the server, the current values of the set of neural network parameters of the neural network using the noisy gradients generated by the remotely located user device.

According to a fourth aspect, there is provided the methods of the first aspect, second aspect, or third aspect performed by a system comprising: one or more computers; and one or more storage devices communicatively coupled to the one or more computers, where the one or more storage devices store instructions that, when executed by the one or more computers, cause the one or more computers to perform operations of the respective method.

According to a fifth aspect, there is provided the methods of the first aspect, second aspect, or third aspect performed by one or more non-transitory computer storage media storing instructions that when executed by one or more computers cause the one or more computers to perform operations of the respective method.

Other features, aspects, and advantages of the subject matter will become apparent from the description, the drawings, and the claims.

### BRIEF DESCRIPTION OF THE DRAWINGS

FIG. 1A shows a visual flow diagram of an example process for applying a plurality of noise values to gradients of an objective function to generate noisy gradients.

FIG. 1B shows a neural network training system.

FIG. 2 is a flow diagram of an example process for training the neural network on a set of training examples to perform a machine learning task.

FIG. 3 is a flow diagram of an example process for determining a correlation matrix used during the training of a neural network.

FIG. 4 is a flow diagram of an example process for partitioning a set of training examples for training a neural network.

FIG. 5 is a flow diagram of an example process for training a neural network in a distributed client-server environment.

FIG. 6 is an example visualization of partitions of a set of training examples for training a neural network.

FIG. 7 is an example of the performance of the described techniques.

FIG. 8 is an example of the performance of the described techniques.

FIG. 9 is an example of the performance of the described techniques.

Like reference numbers and designations in the various drawings indicate like elements.

### DETAILED DESCRIPTION

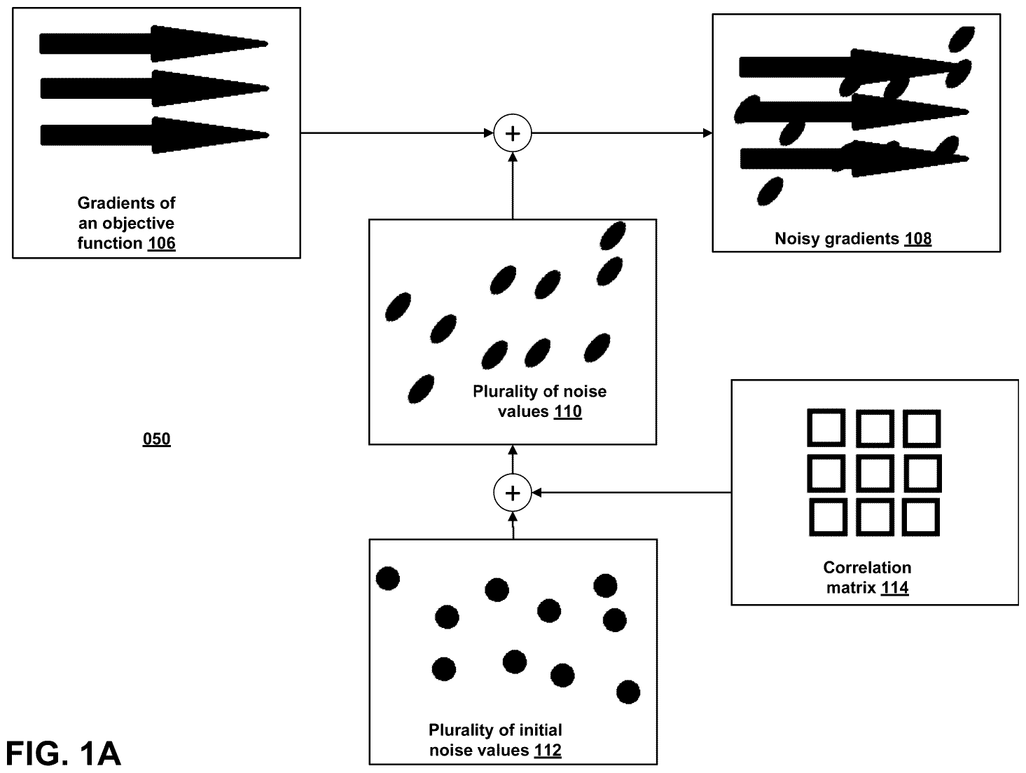

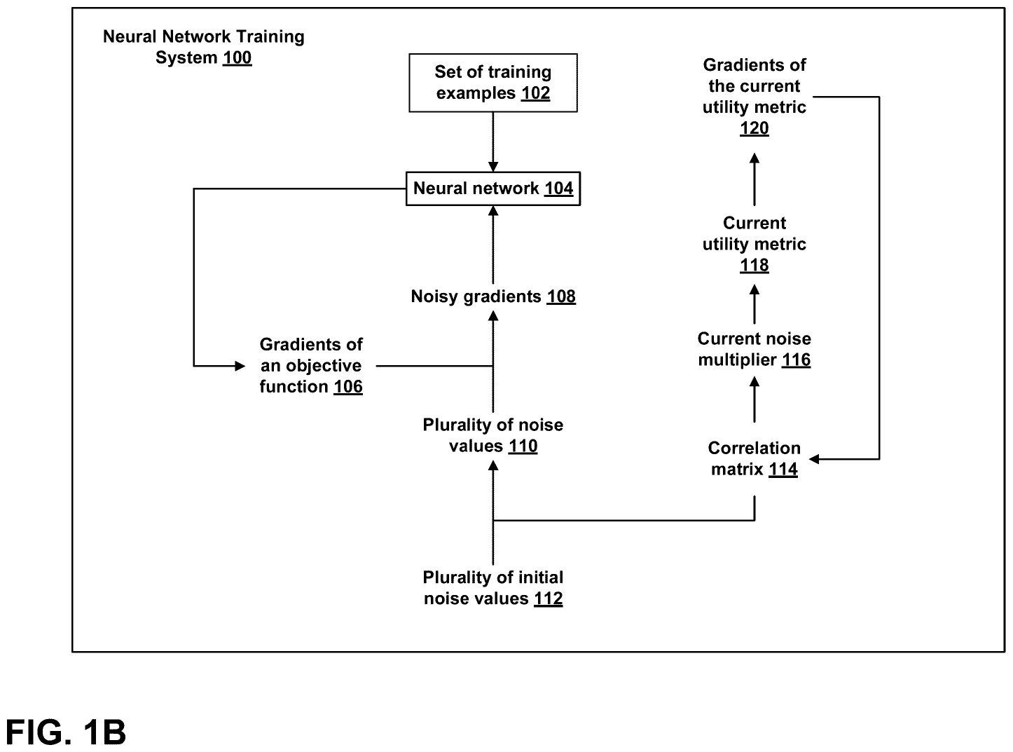

FIG. 1A shows a visual flow diagram of an example process 50 for applying a plurality of noise values to gradients of an objective function to generate noisy gradients. The process 50 illustrates the core mechanism of differentially private stochastic gradient descent (DP-SGD) with correlated noise. Further details of the components in this process 50 are described below with reference to FIG. 1B.

The example process 50 begins by generating a plurality of noise values 110 by first sampling a plurality of initial noise values 112, represented as independent circles, from a noise distribution. Then, the process 50 includes applying a correlation matrix 114 to these initial values 112, transforming them into the plurality of noise values 110, which are represented as correlated ellipses.

Separately, the process 50 includes determining the gradients of an objective function 106, represented as straight vectors. The plurality of noise values 110 are then combined with the gradients 106, for example by element-wise addition, to generate the final noisy gradients 108, which are represented as perturbed vectors. These noisy gradients 108 are then used to update the parameters of a neural network.

FIG. 1B shows an example neural network training system 100. The neural network training system 100 is an example of a system implemented as computer programs on one or more computers in one or more locations, in which the systems, components, and techniques described below can be implemented.

The system 100 trains the neural network 104 to perform a machine learning task, in particular, by repeatedly updating the values of the network parameters of the neural network 104 to optimize an objective function, as will be described in more detail below.

The neural network 104 can be configured to process any appropriate network input. For example, the network input can include an image, an audio waveform, a point cloud (e.g., generated by a lidar or radar sensor), a representation of a protein, a sequence of words (e.g., that form one or more sentences or paragraphs), a video (e.g., represented a sequence of video frames), or a combination thereof.

The neural network 104 can be configured to generate any appropriate neural network output that characterizes the network input. For example, the neural network output can be a classification output, a regression output, a sequence output (i.e., that includes a sequence of output elements), a segmentation output, or a combination thereof.

In some implementations, the system 100 trains the neural network 104 to process a set of network inputs that represent the pixels of an image to generate a classification output that includes a respective score for each object category in a set of possible object categories (e.g., vehicle, pedestrian, bicyclist, etc.). The score for an object category can define a likelihood that the image depicts an object that belongs to the object category.

In some implementations, the system 100 trains the neural network 104 to process a set of network inputs that represent audio samples in an audio waveform to perform speech recognition, i.e., to generate an output that defines a sequence of phonemes, graphemes, characters, or words corresponding to the audio waveform.

In some implementations, the system 100 trains the neural network 104 to process a set of network inputs that represent words in a sequence of words to perform a natural language processing task, e.g., topic classification or summarization. To perform topic classification, the system 100 trains the neural network 104 to generate a network output that includes a respective score for each topic category in a set of possible category categories (e.g., sports, business, science, etc.). The score for a topic category can define a likelihood that the sequence of words pertains to the topic category. To perform summarization, the system 100 trains the neural network 104 to generate a network output that includes an output sequence of words that has a shorter length than the input sequence of words and that captures important or relevant information from the input sequence of words.

In some implementations, the system 100 trains the neural network 104 for a neural machine translation task, e.g., to process a set of network inputs that represent a sequence of text, e.g., a sequence of words, phrases, characters, or word pieces, in one language, to generate a network output that can be a translation of the sequence of text into another language, i.e., a sequence of text in the other language that is a translation of the input sequence of text. As a particular example, the task can be a multi-lingual machine translation task, where the neural network 104 is configured to translate between multiple different source language-target language pairs. In this example, the source language text can be augmented with an identifier that indicates the target language into which the neural network 104 should translate the source language text.

In some implementations, the system 100 trains the neural network 104 to perform an audio processing task. For example, if the network inputs represent a spoken utterance, then the output generated by the neural network 104 can be a score for each of a set of pieces of text, each score representing an estimated likelihood that the piece of text is the correct transcript for the utterance. As another example, if the network inputs represent a spoken utterance, the output generated by the neural network can indicate whether a particular word or phrase (“hotword”) was spoken in the utterance. As another example, if the network inputs represent a spoken utterance, the output generated by the neural network can identify the natural language in which the utterance was spoken.

In some implementations, the system 100 trains the neural network 104 to perform a natural language processing or understanding task, e.g., an entailment task, a paraphrase task, a textual similarity task, a sentiment task, a sentence completion task, a grammaticality task, and so on, that operates on a set of network inputs representing text in some natural language.

In some implementations, the system 100 trains the neural network 104 to perform a text to speech task, where the network inputs represent text in a natural language or features of text in a natural language and the network output is a spectrogram, a waveform, or other data defining audio of the text being spoken in the natural language.

In some implementations, the system 100 trains the neural network 104 to perform a health prediction task, where the network inputs represent data derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

In some implementations, the system 100 trains the neural network 104 to perform a text generation task, where the network inputs represent a sequence of text, and the output is another sequence of text, e.g., a completion of the input sequence of text, a response to a question posed in the input sequence, or a sequence of text that is about a topic specified by the first sequence of text. As another example, the network inputs can represent data other than text, e.g., an image, and the output sequence can be text that describes the data represented by the network inputs.

In some implementations, the system 100 trains the neural network 104 to perform an image generation task, where the network inputs represent a conditioning input and the output is a sequence of intensity value inputs for the pixels of an image.

In some implementations, the system 100 trains the neural network 104 to perform an agent control task, where the network inputs represent a sequence of one or more observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

In some implementations, the system 100 trains the neural network 104 to perform a genomics task, where the network inputs represent a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some implementations, the system 100 trains the neural network 104 to perform a protein modeling task, e.g., where the network inputs represent a protein and the network output characterizes the protein. For example, the network output can characterize a predicted stability of the protein or a predicted structure of the protein.

In some implementations, the system 100 trains the neural network 104 to perform a point cloud processing task, e.g., where the network inputs represent a point cloud (e.g., generated by a lidar or radar sensor) and the network output characterizes, e.g., a type of object represented by the point cloud.

In some implementations, the system 100 trains the neural network 104 to perform a multi-modal data processing task that involves processing a network input that includes multiple types of data, e.g., two or more of: image data, video data, audio data, text data, point cloud data, protein sequence data, protein structure data, and so forth.

In some implementations, the system 100 trains the neural network 104 to perform a language modeling task, e.g., a next character prediction task. In these cases, the neural network can be implemented as an autoregressive neural network. After training, the neural network 104 can be deployed to perform any of a variety of possible tasks, e.g., including tasks that are specified in the input to the neural network.

In some implementations, the system 100 trains the neural network 104 to perform a combination of multiple individual machine learning tasks, e.g., two or more of the machine learning tasks mentioned above. For example, the neural network 104 can be configured to perform multiple individual natural language understanding tasks, with the network inputs processed by the neural network 104 including an identifier for the individual natural language understanding task to be performed on network inputs.

The neural network 104 can have any appropriate neural network architecture that enables it to perform its described functions, e.g., performing a machine learning task by processing network inputs to generate corresponding network outputs. In particular, the neural network can include any appropriate types of neural network layers (e.g., fully-connected layers, convolutional layers, attention layers, message passing layers, recurrent layers, etc.) in any appropriate number (e.g., 10 layers, 100 layers, or 1000 layers), and connected in any appropriate configuration (e.g., as a directed graph of layers).

Generally, the objective function being optimized by the system 100 can be any appropriate function that depends on network outputs generated by the neural network 104. For example, if the machine learning task is a classification task, then the objective function can include a cross-entropy loss term, e.g., that measures a cross entropy between: (1) network outputs generated by the neural network, and (2) target outputs (i.e., that should be generated by the neural network 104). As another example, if the machine learning task is a regression task, then the objective function can include a squared-error loss term, e.g., that measures a squared error between: (1) network outputs generated by the neural network, and (2) target outputs (i.e., that should be generated by the neural network).

The system 100 trains the neural network 104 based on a set of training data 102. The training data 102 includes multiple training examples, where each training example includes a network input, and optionally, a target output that should be generated by the neural network by processing the network input. Generally, the network inputs to the neural network 104 and the network outputs of the neural network can be represented as ordered collections of numerical values (e.g., as vectors or a matrices of numerical values).

In particular, to train the neural network 104 to perform a machine learning task on a set of training examples 102, the system 100 performs the following sequence of operations at each of a plurality of training iterations.

First, the system 100 determines gradients of an objective function 106 with respect to a set of neural network parameters of the neural network 104.

As described above, the objective function can be any appropriate function that depends on network outputs generated by the neural network 104 and the task the neural network 104 performs.

As an example of computing the gradients of an objective function 106, the system 100 can determine the gradients of an objective function 106 using automatic differentiation, e.g., using software libraries that perform automatic differentiation.

After determining these gradients 106, the system 100 generates a plurality of noise values 110 for modifying the gradients of the objective function 106. Generally, to generate the plurality of noise values 110, the system 100 stochastically samples a plurality of initial noise values 112 from a noise distribution that is parametrized by a noise multiplier. Then, the system 100 generates the noise values 110 by applying a correlation matrix 114 to the plurality of initial noise values 112.

For example, to stochastically sample from a noise distribution, the system 100 can draw random values from a pre-defined probability distribution, such as a Gaussian (Normal) distribution that is parameterized by the noise multiplier σ, which is a scalar value that controls the magnitude or scale of the noise. For example, for a Gaussian distribution, the noise multiplier determines the standard deviation.

As a particular example, if the system 100 needs to generate noise for two neural network parameters, it can sample two values from a Gaussian distribution with a mean of 0 and a standard deviation determined by the noise multiplier.

The correlation matrix 114 defines the interdependencies between the noise values 110 at different training iterations. Applying the correlation matrix 114 to the initial noise values transforms the noise values 110 of different training iterations from independent random values into a sequence of correlated noise values.

Once the noise values 110 are generated, the system 100 generates noisy gradients 108 by combining the plurality of noise values 110 with the gradients of the objective function 106.

For example, the system 100 can combine the noise 110 with the gradients 106 using element-wise addition. Each noise value in the plurality of noise values 110 corresponds to a specific gradient value for a neural network parameter 106, and the system 100 adds the corresponding values together to generate the corresponding noisy gradient 108 value. For example, if a gradient for a particular parameter is 0.5 and the corresponding generated noise value is −0.1, the resulting noisy gradient for that parameter would be 0.4.

Then, the system 100 updates the set of neural network parameters of the neural network 104 using the noisy gradients 108.

For example, the system 100 can update the neural network parameters by adjusting the current value of each parameter based on its corresponding noisy gradient 108. For example, the system 100 can subtract the noise gradient of a parameter, multiplied by a scalar, from the current parameter value.

The system 100 can repeat the training iterations until one or more stopping criteria are met. For example, the system 100 repeat the training iterations for a pre-determined number training iterations, or until the updates to the parameters no longer exceed a pre-determined magnitude of change, and so on.

The system 100 determines the correlation matrix 114 used during the training of the neural network 104 through a separate optimization procedure than that the system 100 uses to update the neural network parameters of the neural network 104. In particular, the determine the correlation matrix 114, the system 100 iteratively updates a current correlation matrix 114 over a plurality of optimization iterations to optimize a utility metric, which includes the following operations at each optimization iteration.

The system 100 determines a current noise multiplier 116 that, if used in conjunction with the current correlation matrix 114 during the training of the neural network 104, is predicted to cause the trained neural network 104 to satisfy a data security criterion.

In some implementations, the data security criterion is an (ϵ, δ)-differential privacy (DP) criterion, where ϵ is a target privacy budget parameter defining a bound on a privacy loss, and δ is a target privacy breach parameter defining a bound on a probability of a privacy loss exceeding the privacy budget parameter ϵ.

The noise multiplier 116 can be a scalar value that parameterizes a noise distribution (e.g., a scalar value that controls the magnitude or scale of the noise). For example, the noise multiplier 116 can determine the variance of a distribution, e.g., when sampling from a Gaussian distribution, where a larger noise multiplier can result in the distribution having a larger variance.

In some cases, the noise multiplier 116 corresponding to the last optimization iteration that determines the correlation matrix 114 is the same noise multiplier the system 100 uses to generates the noise values 110 by applying a correlation matrix 114 to the plurality of initial noise values 112 described above.

In some implementations, the system 100 determines the current noise multiplier 116 that is predicted to cause the trained neural network 104 to satisfy a data security criterion using a δ-estimation function. In particular, the δ-estimation function is configured to process an input correlation matrix 114, an input noise multiplier 116, and an input privacy budget parameter (e.g., the ϵ target privacy budget described above) to generate a Monte Carlo estimate \hat{δ} of a corresponding privacy breach parameter δ.

After determining the noise multiplier 116, the system 100 determines a current utility metric 118 for the current correlation matrix 114 based at least in part on the current noise multiplier 116.

A utility metric 118 is a function that quantifies the expected performance of a given correlation matrix 114. The goal of the system 100 optimizing the correlation matrix 114 is to find the correlation matrix 114 that optimizes this metric. Some examples of utility metrics include the total noise variance or the maximum error introduced by the noise. Another example utility metric is the Root Mean Squared Error (RMSE), which the system 100 can calculate as σ·|A⁻¹C|, where σ is the current noise multiplier, A is an all-ones lower-triangular matrix, C is the current correlation matrix, and |·| is a norm operation, e.g., the Frobenius norm.

The system 100 then determines gradients of the current utility metric 120 with respect to the current correlation matrix 114. The system 100 determines these gradients 120 to identify how to adjust the correlation matrix 114 to optimize the utility metric most effectively 118.

In some implementations, to determine gradients of the current utility metric 120 with respect to the current correlation matrix 114, the system 100 determines gradients, with respect to the current correlation matrix 114, of a δ-estimation function. The δ-estimation function can be configured to process an input correlation matrix 114, an input noise multiplier 116, and an input privacy budget parameter to generate a Monte Carlo estimate of a corresponding privacy breach parameter, and the system 100 can determine the gradients of the current utility metric 120 based at least in part on the gradients of the δ-estimation function.

In some implementations, to determine gradients of the current utility metric 120 with respect to the current correlation matrix 114, the system 100 determines gradients, with respect to the current noise multiplier 116, of a δ-estimation function. The δ-estimation function can be configured to process an input correlation matrix 114, an input noise multiplier 116, and an input privacy budget parameter to generate a Monte Carlo estimate of a corresponding privacy breach parameter, and the system 100 can determine the gradients of the current utility metric 120 based at least in part on the gradients of the δ-estimation function.

So, in some cases, because the utility metric 118 can depend on the noise multiplier, which in turn depends on the correlation matrix, the system 100 can use implicit differentiation to calculate the gradients 120. That is, the system 100 can calculate the gradients of the δ-estimation function with respect to both the correlation matrix and the noise multiplier. For example, the final gradient 120 can be computed using an expression that combines the partial derivative of the utility metric 118 with respect to the correlation matrix 114 and the partial derivatives of the δ-estimation function.

In some cases, during the iterative updates to the current correlation matrix 114 over the plurality of optimization iterations, the system 100 constrains the form of the current correlation matrix 114. For example, the system 100 can constrain the current correlation matrix 114 to remain in a lower-dimensional subspace of a space of possible correlation matrices. As a particular example, the lower-dimensional subspace can include a space of Toeplitz matrices.

Then, the system 100 updates the current correlation matrix 114 using the gradients of the current utility metric 120.

The system 100 can update the correlation matrix 114 by adjusting its current values based on the calculated gradients 120, consistent with gradient-based optimization methods. For example, the system 100 can use a gradient descent update rule, where the current correlation matrix 114 is updated by subtracting the gradients of the utility metric 120, scaled by an optimization learning rate.

The system 100 repeats the optimization iterations until one or more stopping criteria are met. For example, the system 100 can repeat the optimization iterations for a pre-determined number of iterations, or until the updates to the correlation matrix no longer exceed a pre-determined magnitude of change, or until the utility metric no longer changes values to within a tolerance between iterations and so on.

The system 100 also can also partition the set of training examples 102 for training the neural network 104. Partitioning the set of training examples 102 can introduce randomness into the batching process during training contribute to causing the trained neural network 104 to satisfy a data security criterion (e.g., the (ϵ, δ)-differential privacy criterion described above). For example, partitioning the set of training examples 102 can be part of a “privacy amplification” technique that uses randomness in data processing to strengthen the privacy guarantees of a differentially private training process.

To begin the process of partitioning the set of training examples 102, the system 100 obtains a set of training examples 102.

The system 100 can obtain the set of training examples 102 from any of a variety of sources including a user, system maintained data, or another system. For example, the system 100 can receive the set of training examples 102 over a network connection, e.g., a cloud-based network, the internet, or a local network.

Then the system 100 partitions the set of training examples 102 into a plurality of batches. A batch is a subset of the set training examples 102 that is can be used in a single training iteration. For an entire training process, which can consist of multiple passes over the set of training examples (called epochs), the system 100 can divide the training examples into many such batches.

Generally, to partition the set of training examples 102 into a plurality of batches, the system 100 first shuffles the set of training examples 102. That is, the system randomly reorders the training examples to ensure that any inherent ordering in the original dataset is removed.

Then, the system 100 samples a batch size schedule. A batch size schedule is a sequence of numbers that dictates the size of each batch to be created. The system 100 samples this schedule from a multinomial distribution, which assigns each training example randomly to one of several batches.

Afterwards, the system 100 selects the batches from the shuffled set of training examples 102 in accordance with the batch size schedule. The system 100 processes the shuffled training examples sequentially, taking the first number from the schedule to form the first batch, the next number to form the second batch, and so on, until all examples are assigned to a batch.

With the batches determined, the system 100 then trains a neural network 104 on a respective batch of training examples at each of a plurality of training iterations.

Each training iteration involves using a single batch of training examples to perform the sequence of operations described above to train the neural network 104. For example, the system 100 computes the gradients of an objective function 106 for all examples in the current batch, applies the plurality of noise values 110 to the gradients 106 to generate noisy gradients 108, and then updates the neural network 104 parameters.

In some implementations, the system 100, in response to determining that a batch includes more than a threshold number of training examples, truncates the batch to have the threshold number of training examples. For example, if the batch size schedule produces a batch with one hundred and five examples but the system 100 hardware is optimized for a maximum of one hundred examples, the system 100 can randomly discard five examples from that batch before using it for training.

In some implementations, the system 100, in response to determining that a batch includes less than a threshold number of training examples, pads the batch to have the threshold number of training examples. Padding the batch can include adding dummy training examples into the batch, wherein each dummy training example is associated with zero gradients.

An advantage of the system 100 truncating and padding batches is that it allows the system 100 to use fixed-size batches, and fixed-size batches can be compatible with machine learning hardware and software accelerators (e.g., those using XLA compilation).

In some cases, after training the neural network 104, the system 100 can use the neural network 104 perform its specified machine learning task. That is, the system 100 receives a network input to the neural network 104 and processes the network input using the trained neural network 104 to generate a corresponding network output. After which, the system 100 provides the network output generated by the neural network 104. For example, the system 100 provides the network output to a user via a user device or to another system (e.g., for further processing).

In some implementations, the system 100 operates in a distributed, client-server environment, e.g., for federated learning. In this configuration, a central server can be responsible for determining the optimized correlation matrix 114 and maintaining the current values of the neural network parameters 104. The server can transmit the current parameters and the correlation matrix 114 to one or more remotely located user devices. Each user device, acting as a client, can then perform one or more training iterations (e.g., as described above) on its own locally stored set of training examples. Specifically, a client device can generate noisy gradients 108 by performing DP-SGD using the server-provided correlation matrix 114. The client device can then transmit these noisy gradients 108 back to the server. Finally, the server can update the global set of neural network parameters using the noisy gradients 108 received from one or more client devices.

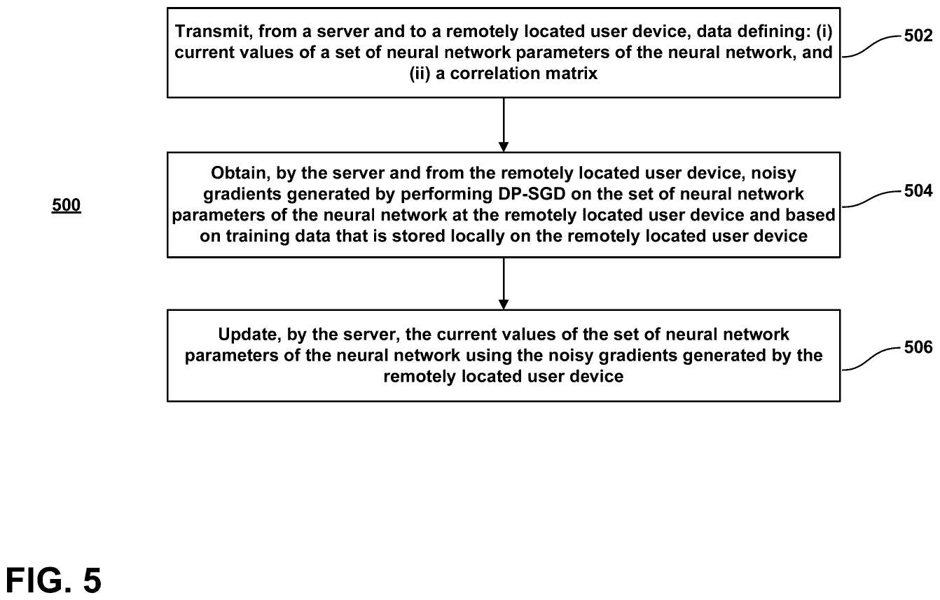

Furter details of training a neural network in a distributed client-server environment are described below with reference to FIG. 5.

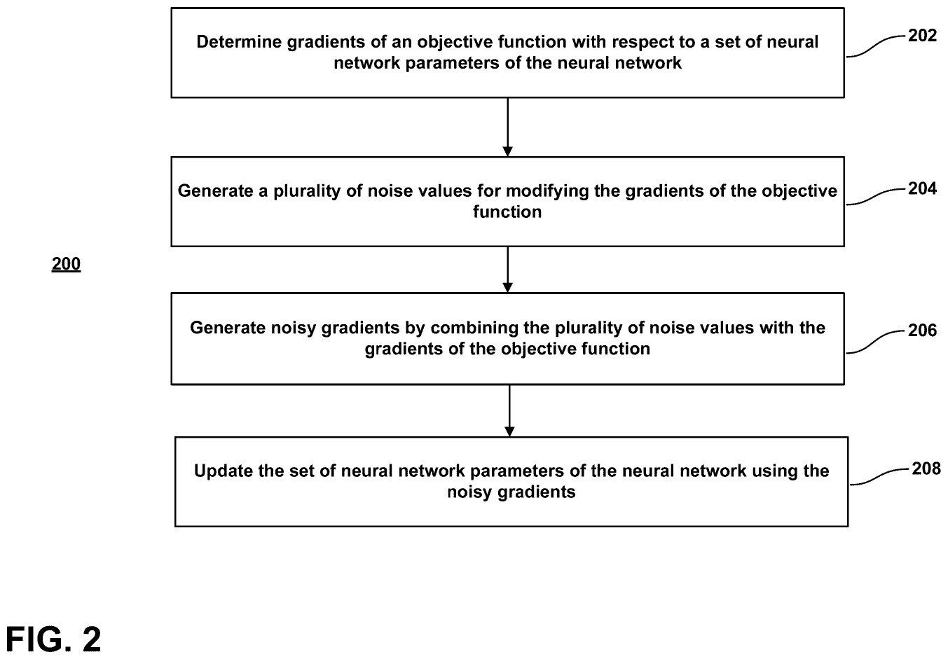

FIG. 2 is a flow diagram of an example process 200 for training the neural network on a set of training examples to perform a machine learning task. For convenience, the process 200 will be described as being performed by a system of one or more computers located in one or more locations. For example, a computer system, e.g., the neural network training system 100 of FIG. 1B, appropriately programmed in accordance with this specification, can perform the process 100.

As described above, the neural network can have any of a variety of neural network architectures. That is, the neural network can have any appropriate architecture in any appropriate configuration that is appropriate for the task it performs, including fully connected layers, convolutional layers, recurrent layers, attention-based layers, and so on, as is appropriate.

As described above, the neural network can be configured to perform any of a variety of types of machine learning tasks.

For example, the neural network can be configured to perform an image processing task that includes processing an input image to generate a prediction characterizing the input image.

For example, the neural network can process an image of a handwritten digit and generate a classification output indicating which digit (0-9) the image most likely represents.

As another example, the neural network can be configured to perform an audio processing task that includes processing input audio data to generate a prediction characterizing the input audio data.

For example, a neural network can process a short audio clip of a person speaking and generate a prediction of the intended action the person wishes to execute (e.g., voice command to send an email).

As another example, the neural network can be configured to perform a video processing task that includes processing input video data to generate a prediction characterizing the input video data.

For example, a neural network can process a video of a street scene and generate outputs that identify and track the locations of vehicles and pedestrians frame by frame.

To train the neural network to perform a machine learning task on a set of training examples, the system performs the following operations at each of a plurality of training iterations.

The system determines gradients of an objective function with respect to a set of neural network parameters of the neural network (step 202).

As described above, the objective function can be any appropriate function that depends on network outputs generated by the neural network and the task the neural network performs.

For example, if the task is to classify images, the objective function can include a cross-entropy loss function that measures the difference between the network's predicted classification and the true, labeled classification for a given training image.

The system generates a plurality of noise values for modifying the gradients of the objective function (step 204).

As described above, generally, to generate the plurality of noise values, the system stochastically samples a plurality of initial noise values from a noise distribution that is parametrized by a noise multiplier. Then, the system generates the noise values by applying a correlation matrix to the plurality of initial noise values.

For example, the system can use a noise multiplier σ calibrated to provide a specific (ϵ,δ)-differential privacy guarantee, where the calibration of σ is performed by a separate optimization (e.g., as described above). The system can sample the initial noise values z independently for each neural network parameter from a normal distribution like N (0, σ2I), where I is the identity matrix. The system then generates the final noise values by taking the product of the inverse of the optimized correlation matrix C⁻¹ and the initial noise values z (i.e., C⁻¹z).

The system generates noisy gradients by combining the plurality of noise values with the gradients of the objective function (step 206).

For example, the system can perform an element-wise addition of the gradients computed for a batch of training data x and the final noise values computed for that iteration C⁻¹z, e.g., as described above, i.e., x+C⁻¹z.

The system updates the set of neural network parameters of the neural network using the noisy gradients (step 208).

For example, as described above, the system can adjust the current neural network parameters θₜ by subtracting the noisy gradients, scaled by a learning rate η. For example, the updated parameters θₜ₊₁, can be calculated by summing the original parameters with the noisy gradients, as in the update rule, e.g., θₜ−η(x+C⁻¹z).

In some implementations, after the system trains the neural network, the system processes network input using the trained neural network to generate a corresponding network output.

That is, the system receives a network input to the neural network, where the network input is one aligned with the task that the neural network was trained to perform.

For example, in the context of a neural network trained by the system to perform next-word prediction, the network input could be a sequence of characters or words typed by a user.

As another example, in the context of a neural network trained by the system to perform image recognition, the network input could be an image to be classified.

Then, the system processes the network input using the trained neural network to generate a corresponding network output.

The system then provides the network output generated by the neural network, e.g., a predicted next word or an image classification label. The system can provide this output to a user through a user device (e.g., the system suggests the predicted word in a keyboard interface of a smart phone), or to another system (e.g., the system sends the classification label to another system to sort images).

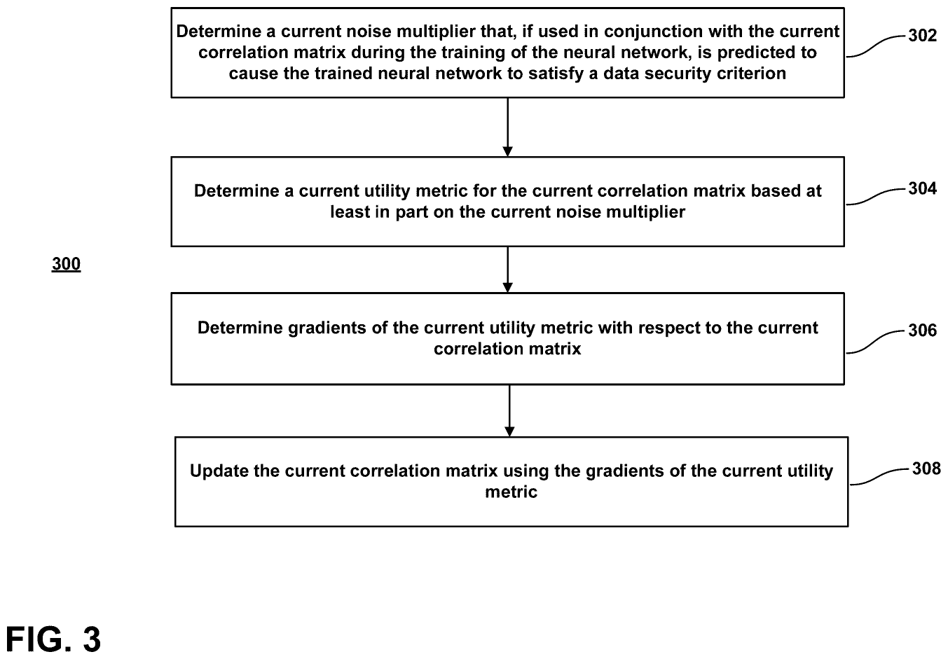

FIG. 3 is a flow diagram of an example process 300 for determining a correlation matrix used during the training of a neural network. For convenience, the process 300 will be described as being performed by a system of one or more computers located in one or more locations. For example, a computer system, e.g., the neural network training system 100 of FIG. 1B, appropriately programmed in accordance with this specification, can perform the process 100.

To determine the correlation matrix the system uses during the training of the neural network (e.g., example process 200), the system iteratively updates a current correlation matrix over a plurality of optimization iterations to optimize a utility metric. In particular, at each optimization iteration, the system performs the following operations.

The system determines a current noise multiplier that, if used in conjunction with the current correlation matrix during the training of the neural network, is predicted to cause the trained neural network to satisfy a data security criterion (step 302).

As described above, in some implementations, the data security criterion is an (ϵ, δ)-differential privacy (DP) criterion, where ϵ is a target privacy budget parameter defining a bound on a privacy loss, and δ is a target privacy breach parameter defining a bound on a probability of a privacy loss exceeding the privacy budget parameter ϵ.

In some cases, when the system determines the noise multiplier, the system determines the current noise multiplier using a δ-estimation function that is configured to process an input correlation matrix, an input noise multiplier, and an input privacy budget parameter to generate a Monte Carlo estimate of a corresponding privacy breach parameter.

In some cases, the δ-estimation function is configured to generate the Monte Carlo estimate of the corresponding privacy breach parameter as an average of a plurality of stochastic estimates of the privacy breach parameter. Each of the plurality of stochastic estimates of the privacy breach parameter is based at least in part on one or more random values that are sampled from one or more probability distributions, where the plurality of stochastic estimates of the privacy breach parameter are generated substantially in parallel.

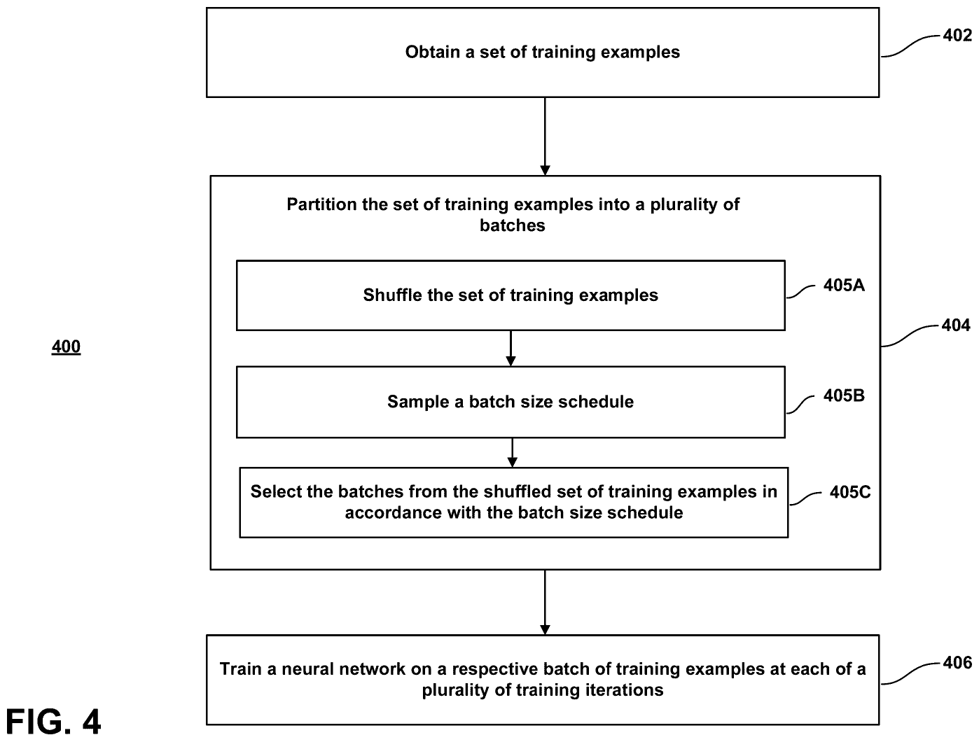

As a particular example of the δ-estimation function (denoted as \hat{δ}) the δ-estimation function can be

$$\hat{δ} ( σ ; C , ϵ , {i}_{1 : m} , {Z}_{1 : m} ) = \frac{1}{m} {\sum }_{j = 1}^{m} {( 1 - exp ( ϵ - {Y}_{j} ( σ ) ) )}_{+} ,$$

where σ is the noise multiplier; C is the correlation matrix; E is the privacy budget; m is the sample size, i.e., the total number of stochastic estimates used in the Monte Carlo estimation; j is the index of summation for each of the m stochastic estimates; and Yⱼ(σ) is the j-th stochastic estimate of a privacy loss random variable. It is a “stochastic estimate” because its value is derived from random variables that simulate the training process of the neural network. Specifically, its value is calculated from the log-likelihood ratio of two distributions that model a training process that includes partitioning the set of training examples into b batches (as will be described in more detail below with reference to FIG. 4) with and without a specific training example's data, using a randomly sampled batch index (iⱼ) and random noise values (Zⱼ) from the probability distributions Uni([b]) and N(0,I) respectively; and the subscript + on the expression is the notation for the max function max (0,expression). The system can determine the term Yⱼ(σ) as

$$log ( \frac{{P}_{C , σ}}{{Q}_{σ}} ( {m}_{{i}_{j}} + σ \cdot {Z}_{j} ) ) .$$

The terms P_{C,σ} and Q_{σ} represent the described probability distributions above. For example, the term Q_{σ}= [symbol] (0,σ²I) can be a multivariate normal (Gaussian) distribution with a mean of zero and variance determined by the noise multiplier σ. The term

$${P}_{C , σ} = \frac{1}{b} {\sum }_{i = 1}^{b} 𝒩 ( {m}_{i} , {σ}^{2} I )$$

can be a mixture of b different Gaussian distributions corresponding to the b batches of the partitioned set of training examples, where the mean of each component Gaussian is determined by the correlation matrix C as

$${m}_{i} = {\sum }_{j = 0}^{E - 1} {\vert C \vert}_{1 : n , b \cdot j + i}$$

and E stands for the number epochs during the simulated training process.

In some cases, when the system determines the current noise multiplier using a δ-estimation function, the system selects the current noise multiplier so that processing the current correlation matrix, the current noise multiplier, and a target privacy budget parameter ϵ using the δ-estimation function causes the δ-estimation function to generate an estimated privacy breach parameter that is within a tolerance threshold of a target privacy breach parameter δ.

For example, the system can determine the solution to \hat{δ}(σ; C, Σ, i_{1:m}, Z_{1:m})=δ to within a Δ additive error due to the Monte Carlo sampling error, using the above described method to compute \hat{δ} for various values of the noise multiplier σ.

In some implementations, the current noise multiplier is selected using a bisection algorithm. Generally, the bisection algorithm is a numerical root-finding method that efficiently solves the equation \hat{δ}(σ)=δ for the noise multiplier σ. The algorithm can start with an initial search interval for σ and, in each step, repeatedly narrows that interval by half until it converges on the specific value of σ that causes the estimated privacy breach parameter, \hat{δ}, to match the target, δ, within a desired tolerance (e.g., Δ as described above).

Algorithm 1 below is an example of determining a current noise multiplier that, if used in conjunction with the current correlation matrix during the training of the neural network, is predicted to cause the trained neural network to satisfy a data security criterion.

Algorithm 1 Finding σ

Inputs: Target (ϵ, δ)-DP guarantee, sample size m, matrix C.
$1 : {i}_{1} … {i}_{m} {∼}^{iid} Uni ( [ b ] )$
$2 : {Z}_{1} , … , {Z}_{m} {∼}^{iid} 𝒩 ( 0 , I )$
$3 : Define {Y}_{j} ( σ ) := log ( \frac{{P}_{C , σ}}{{Q}_{σ}} ( {m}_{{i}_{j}} + σ \cdot {Z}_{j} ) )$
$4 : Define the function \hat{δ} as \hat{δ} ( σ ; C , ϵ , {i}_{1 : m} , {Z}_{1 : m} ) = \frac{1}{m} {\sum }_{j = 1}^{m} {( 1 - exp ( ϵ - {Y}_{j} ( σ ) ) )}_{+}$
5: σ* ← solution to \hat{δ}(σ; C, ϵ, i_{1:m}, Z_{1:m}) = δ obtained by some 1-d bisection algorithm
6: Return σ*

In the first two steps of Algorithm 1, the algorithm obtains random inputs, including batch indices iⱼ and initial noise values Zⱼ, as defined above. Step 3 defines the function for calculating a single sample of the privacy loss, Yⱼ(σ), as previously described. Step 4 defines the δ-estimation function (\hat{δ}) as the average of a transformation of these privacy loss samples. Finally, steps 5 and 6 describe using a bisection algorithm to find and return the specific value, σ*, that solves the equation where the output of the δ-estimation function equals the target privacy breach parameter, δ.

The system determines a current utility metric for the current correlation matrix based at least in part on the current noise multiplier (step 304).

As described above, the utility metric is a function that quantifies the expected performance of a given correlation matrix.

In some cases, the system can determine this current utility metric for the current for the current correlation matrix as:

$$σ \cdot \vert {A}^{- 1} C \vert$$

wherein σ is the current noise multiplier, A is an all-ones lower-triangular matrix, C is the current correlation matrix, and |·| is a norm operation.

The system determines gradients of the current utility metric with respect to the current correlation matrix (step 306).

In some cases, to determine gradients of the current utility metric with respect to the current correlation matrix, the system determines gradients, with respect to the current correlation matrix, of a δ-estimation function. The δ-estimation function is configured to process an input correlation matrix, an input noise multiplier, and an input privacy budget parameter to generate a Monte Carlo estimate of a corresponding privacy breach parameter. Then, the system determines the gradients of the current utility metric based at least in part on the gradients of the δ-estimation function. For example, the system can compute the gradient σ\hat{δ}/σC where \hat{δ} is the δ-estimation function as described above and is a function of C, the correlation matrix.

In some cases, to determine gradients of the current utility metric with respect to the current correlation matrix, the system determines gradients, with respect to the current noise multiplier, of a δ-estimation function. The δ-estimation function is configured to process an input correlation matrix, an input noise multiplier, and an input privacy budget parameter to generate a Monte Carlo estimate of a corresponding privacy breach parameter. Then, the system determines the gradients of the current utility metric based at least in part on the gradients of the δ-estimation function. For example, the system can compute the gradient σ\hat{δ}/σC where \hat{δ} is the δ-estimation function as described above and is a function of σ, the noise multiplier.

As a particular example, when the system determines the utility metric is σ·|A⁻¹C| (as described above), the system can determine the gradients of the current utility metric as:

$$σ \cdot \frac{\partial \vert {A}^{- 1} C \vert}{\partial C} - \frac{\vert {A}^{- 1} C \vert ( \frac{\partial \hat{δ}}{\partial C} )}{\frac{\partial \hat{δ}}{\partial σ}}$$

wherein σ is the current noise multiplier, A is an all-ones lower-triangular matrix, C is the current correlation matrix, |·| is a norm operation, a is a partial derivative operator, and \hat{δ} is a δ-estimation function.

The system updates the current correlation matrix using the gradients of the current utility metric (step 308).

In some implementations, to update the current correlation matrix using the gradients of the current utility metric, the system updates the current correlation matrix using the gradients of the current utility metric using a gradient descent optimization technique. For example, the system can optimize the current correlation matrix using batch gradient descent, stochastic gradient descent, or mini-batch gradient descent.

As described above, the system repeats the optimization iterations (i.e., steps 302-308) until one or more stopping criteria are met. For example, the system can repeat the optimization iterations for a pre-determined number of iterations, or until the updates to the correlation matrix no longer exceed a pre-determined magnitude of change, and so on.

In some implementations, during the iterative updates to the current correlation matrix over the plurality of optimization iterations, the system constrains the current correlation matrix to remain in a lower-dimensional subspace of a space of possible correlation matrices.

For example, the system can constrain the current correlation matrix to remain in a lower-dimensional subspace that includes a space of Toeplitz matrices. A Toeplitz matrix is one in which all the values along each diagonal are constant.

As another example, the system can constrain the current correlation matrix to remain in a lower-dimensional subspace that includes a space of block lower triangular matrices.

As another example, the system can constrain the current correlation matrix to remain in a lower-dimensional subspace that includes a space of lower triangular matrices.

As another example, the system can constrain the current correlation matrix to remain in a lower-dimensional subspace that includes a space of Buffered Linear Toeplitz matrices (as described in arXiv:2404.16706).

FIG. 4 is a flow diagram of an example process 400 for partitioning a set of training examples for training a neural network. For convenience, the process 400 will be described as being performed by a system of one or more computers located in one or more locations. For example, a computer system, e.g., the neural network training system 100 of FIG. 1B, appropriately programmed in accordance with this specification, can perform the process 100.

As described above, partitioning the set of training examples can be part of a “privacy amplification” technique. The process 400 introduces randomness into how training examples are grouped into batches, which strengthens the privacy guarantees of the overall training process.

The system obtains a set of training examples (step 402). The system can obtain the set of training examples from any of a variety of sources including a user, system maintained data, or another system.

The system partitions the set of training examples into a plurality of batches (step 404). A batch is a subset of the set of training examples that is used in a single training iteration. For an entire training process, which can consist of multiple passes over the set of training examples (called epochs), the system divides the training examples into many such batches.

Generally, to perform step 404, the system performs the following steps 405A-405C.

The system shuffles the set of training examples (step 405A). That is, the system randomly reorders the training examples to ensure that any inherent ordering in the original dataset is removed.

The system samples a batch size schedule (step 405B). As described above, a batch size schedule is a sequence of numbers that dictates the size of each batch to be created. The system can sample this schedule from a multinomial distribution, which effectively assigns each training example randomly to one of several batches for a given epoch.

The system selects the batches from the shuffled set of training examples in accordance with the batch size schedule (step 405C).

The system processes the shuffled training examples sequentially, taking the first number from the schedule to form the first batch, the next number to form the second batch, and so on, until all examples are assigned to a batch.

The system trains a neural network on a respective batch of training examples at each of a plurality of training iterations (step 406). Each training iteration involves using a single batch of training examples to perform the sequence of operations included in the training iteration, e.g., as described in process 200 above, such as computing gradients, applying correlated noise, and updating the neural network parameters.

In some implementations, the system, in response to determining that a batch includes more than a threshold number of training examples, truncates the batch to have the threshold number of training examples.

For example, as described above, if the schedule produces a batch with one hundred and five examples but the system hardware is optimized for a maximum of one hundred, the system can randomly discard five examples from that batch.

In some implementations, the system, in response to determining that a batch includes less than a threshold number of training examples, pads the batch to have the threshold number of training examples. Padding the batch can include adding dummy training examples into the batch, wherein each dummy training example is associated with zero gradients. For example, if a batch has ninety-five examples and the target size is one hundred, the system can add five dummy examples with zero gradients to the batch. This ensures a fixed batch size, which can improve computational efficiency for modern machine learning frameworks.

FIG. 5 is a flow diagram of an example process 500 for training a neural network in a distributed client-server environment. For convenience, the process 500 will be described as being performed by a system of one or more computers located in one or more locations. For example, a computer system, e.g., the neural network training system 100 of FIG. 1B, appropriately programmed in accordance with this specification, can perform the process 100.

Example process 500 describes a distributed training procedure, such as federated learning, where a central server coordinates training across multiple user (client) devices. The neural network can be any of the types described above and configured to perform any of the machine learning tasks described above.

The system transmits, from a server and to a remotely located user device, data defining: (i) current values of a set of neural network parameters of the neural network, and (ii) a correlation matrix (step 502).

For example, from the server, the system provides the user device with the most up-to-date version of the neural network (i.e., its parameters) and the correlation matrix that the user device will use to generate private, noisy gradients.

The user device can be any device capable of performing local computations and communicating with the server, such as a smart phone, a personal computer, a smart home device, an embedded system in a vehicle, and so on.

For example, the system can transmit, from a central server, the latest version of a next-word prediction neural network and an optimized correlation matrix to a user's smart phone.

The system determines the correlation matrix of step 502 through a series of operations. In particular, to determine the correlation matrix, the system iteratively updates a current correlation matrix over a plurality of optimization iterations to optimize a utility metric.

At each optimization iteration the system determines a current noise multiplier that, if used in conjunction with the current correlation matrix during training of the neural network by differentially private stochastic gradient descent (DP-SGD), is predicted to cause the trained neural network to satisfy a data security criterion.

The noise multiplier is the scalar value that controls the scale of the noise, e.g., as described above with reference to FIG. 3. Also, the training performed by the client device, i.e., differentially private stochastic gradient descent (DP-SGD), can be an instance of the general training process 200 described above.

After determining the current noise multiplier, the system then determines a current utility metric for the current correlation matrix based at least in part on the current noise multiplier.

The utility metric is a function that quantifies the effectiveness of the correlation matrix, e.g., as described above with reference to FIG. 3. For example, the system can use the RMSE as described above as the utility metric.

After determining the current utility metric, the system determines the gradients of the current utility metric with respect to the current correlation matrix.

The system can determine the gradients using, for example, the differentiation method described above with reference to steps 304 and 306 of FIG. 3. That is, the system can calculate the gradients of the δ-estimation function with respect to both the correlation matrix and the noise multiplier to determine the final gradient of the utility metric.

As the last step of optimization iteration, the system updates the current correlation matrix using the gradients of the current utility metric. For example, the system updates the correlation matrix using a gradient-based optimization method, such as gradient descent, e.g., as described above with reference to FIG. 3.

The system obtains, by the server and from the remotely located user device, noisy gradients generated by performing DP-SGD on the set of neural network parameters of the neural network at the remotely located user device and based on training data that is stored locally on the remotely located user device (step 504).

For example, after receiving the neural network (i.e., the neural network parameters) and the correlation matrix, the system uses the user device to perform a training iteration of the neural network on the user device's local training data. For example, the iteration can involve calculating gradients, applying correlated noise using the provided correlation matrix, and producing a set of noisy gradients, e.g., the training iteration can be an instance of the general training process 200 described above. The system then sends these noisy gradients back to the server.

For example, the user's smart phone computes noisy gradients for a next-word prediction neural network based on the user's recent typing data and the system transmits these noisy gradients to the central server.

The system updates, by the server, the current values of the set of neural network parameters of the neural network using the noisy gradients generated by the remotely located user device (step 506).

For example, the server receives noisy gradients from the user device along with one or more other user devices and aggregates them to update the neural network's parameters. As an example, the aggregation can be a simple averaging of the noisy gradients from all participating clients in that round. For example, the server can update the neural network parameters by subtracting the aggregated noisy gradients, scaled by a learning rate, from the current parameter values.

As a particular example, the central server averages the noisy gradients received from the user's smart phone and other participating devices to produce an updated version of the next-word prediction neural network, which will be sent to user devices in the next round of training.

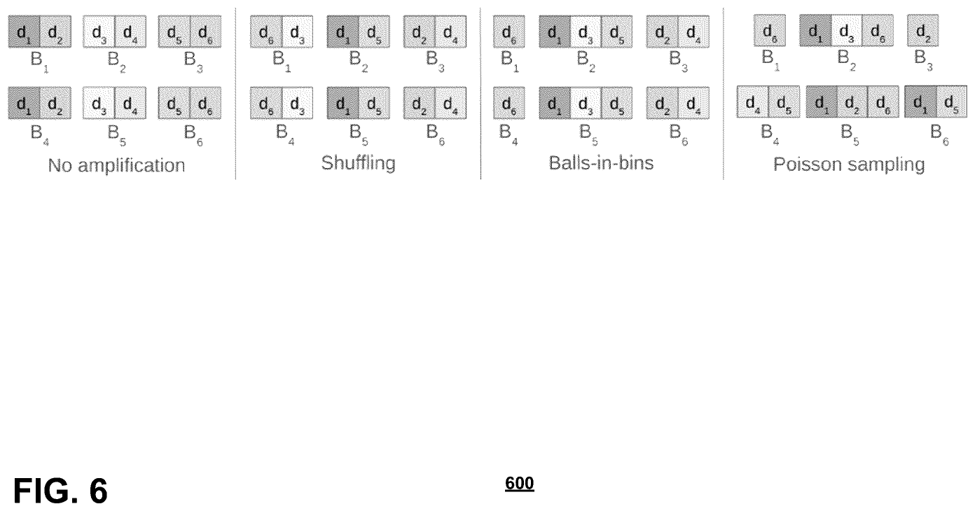

FIG. 6 is an example 600 visualization of partitions of a set of training examples for training a neural network.

In particular, example 600 shows different methods for partitioning a set of training examples into batches for use in training iterations, including a “No amplification” method, a “Shuffling” method, a “Poisson sampling” method, and the “Balls-in-bins” which corresponds to the example process 400 of FIG. 4.

The “Balls-in-bins” forms b=3 batches per epoch for E=2 epochs (visually represented as one row for each epoch) and therefore results in n=b·E=6 total number of training iterations. The system independently included each example in exactly one batch uniformly at random. During training, the system will iterate through the batches in a round robin fashion.

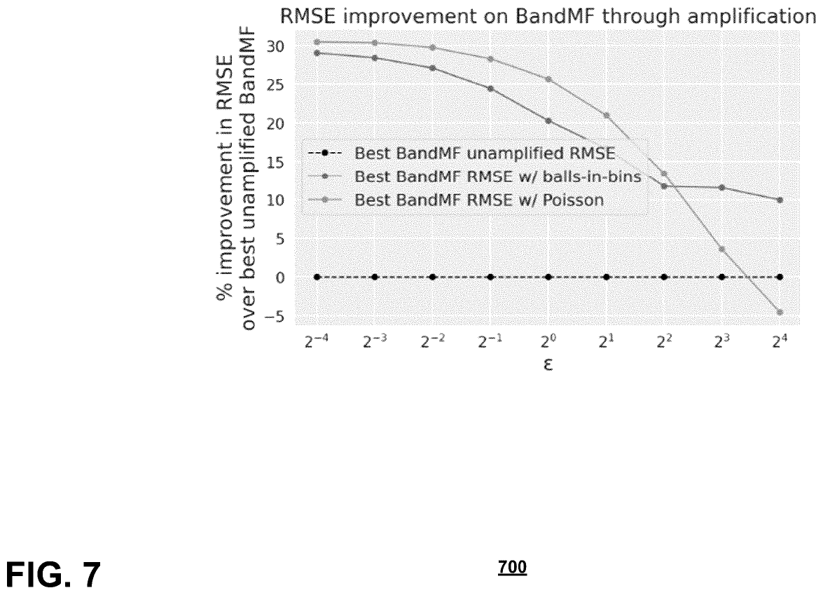

FIG. 7 is an example 700 of the performance of the described techniques. In particular, the example 700 is a graph that illustrates the improvement in a utility metric (Root Mean Squared Error or RMSE) that can be achieved by using a privacy amplification technique (e.g., a partitioning process), such as the “balls-in-bins” partitioning process 400, compared to a baseline without amplification. The graph plots the percent improvement in the utility metric as a function of the privacy budget parameter ϵ.

Example 700 shows that the described techniques (i.e., the curve labeled “Best BandMF RMSE w/balls-in-bin”) outperforms other techniques (e.g., the curve labeled “Best BandMF RMSE w/Poisson”) and the baseline at high privacy budget parameter ϵ values.

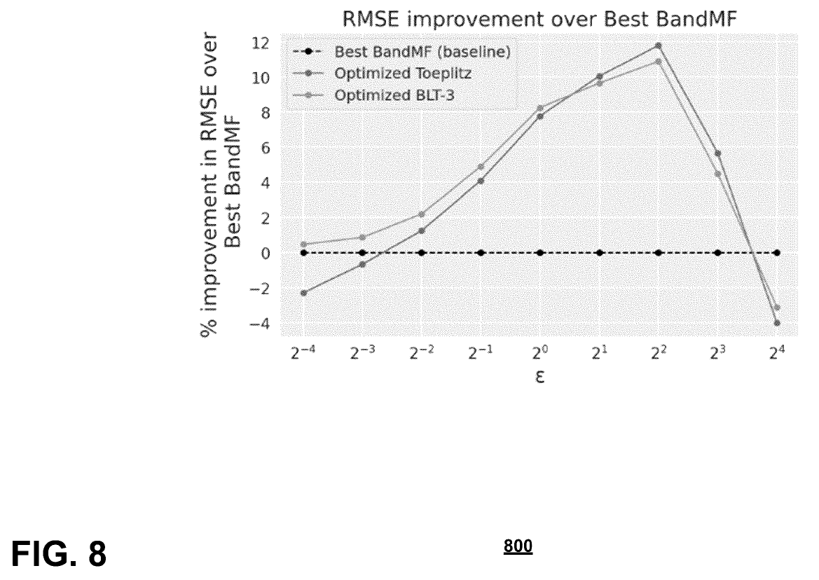

FIG. 8 is an example 800 of the performance of the described techniques. In particular, the example 800 is a graph that illustrates the improvement in a utility metric (RMSE) that can be achieved by using the optimization process 300 to determine the correlation matrix. The graph compares the performance of an optimized Toeplitz constrained correlation matrix and an optimized Buffered Linear Toeplitz (BLT) constrained correlation matrix against a baseline b-banded constrained correlation matrix, as a function of the privacy budget parameter ϵ.

Example 800 shows a significant improvement (lower RMSE) of the described techniques (i.e., the curves labeled “Optimized Toeplitz” and “Optimized BLT-3”) over the baseline for most ϵ values.

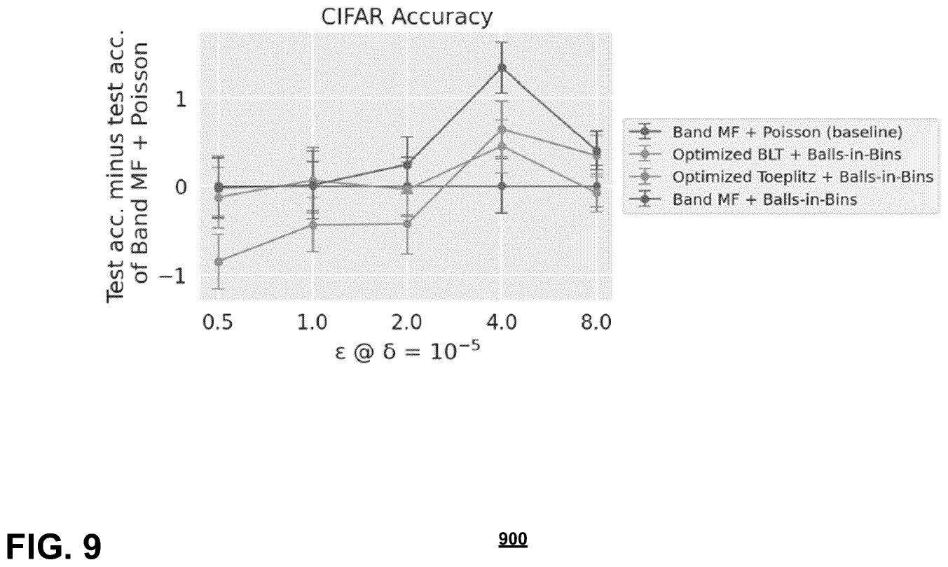

FIG. 9 is an example 900 of the performance of the described techniques. In particular, the example 900 is a graph that shows the improvement in the final test accuracy of a neural network trained using the described techniques on an image classification task. The graph shows that using an optimized correlation matrix (determined by process 300) in conjunction with the “balls-in-bins” partitioning scheme (process 400) can lead to higher test accuracy compared to a baseline, as a function of the privacy budget parameter ϵ.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small, embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers for training of a neural network, the method comprising:
training the neural network on a set of training examples to perform a machine learning task, the training comprising, at each of a plurality of training iterations:
determining gradients of an objective function with respect to a set of neural network parameters of the neural network;
generating a plurality of noise values for modifying the gradients of the objective function, comprising:
stochastically sampling a plurality of initial noise values from a noise distribution that is parametrized by a noise multiplier; and
generating the noise values by applying a correlation matrix to the plurality of initial noise values;
generating noisy gradients by combining the plurality of noise values with the gradients of the objective function; and
updating the set of neural network parameters of the neural network using the noisy gradients;
wherein the correlation matrix used during the training of the neural network is determined by performing operations comprising:
iteratively updating a current correlation matrix over a plurality of optimization iterations to optimize a utility metric, comprising, at each optimization iteration:
determining a current noise multiplier that, if used in conjunction with the current correlation matrix during the training of the neural network, is predicted to cause the trained neural network to satisfy a data security criterion;
determining a current utility metric for the current correlation matrix based at least in part on the current noise multiplier;
determining gradients of the current utility metric with respect to the current correlation matrix; and
updating the current correlation matrix using the gradients of the current utility metric.

2. The method of claim 1, wherein the data security criterion is an (ϵ, δ)-differential privacy (DP) criterion, wherein ϵ is a target privacy budget parameter defining a bound on a privacy loss, and δ is a target privacy breach parameter defining a bound on a probability of a privacy loss exceeding the privacy budget parameter ϵ.

3. The method of claim 1, wherein determining a current noise multiplier that, if used in conjunction with the current correlation matrix during the training of the neural network, is predicted to cause the trained neural network to satisfy the data security criterion comprises:
determining the current noise multiplier using a δ-estimation function that is configured to process an input correlation matrix, an input noise multiplier, and an input privacy budget parameter to generate a Monte Carlo estimate of a corresponding privacy breach parameter.

4. The method of claim 3, wherein the δ-estimation function is configured to generate the Monte Carlo estimate of the corresponding privacy breach parameter as an average of a plurality of stochastic estimates of the privacy breach parameter, wherein each of the plurality of stochastic estimates of the privacy breach parameter is based at least in part on one or more random values that are sampled from one or more probability distributions, wherein the plurality of stochastic estimates of the privacy breach parameter are generated substantially in parallel.

5. The method of claim 3, wherein determining the current noise multiplier using a δ-estimation function comprises selecting the current noise multiplier so that processing the current correlation matrix, the current noise multiplier, and a target privacy budget parameter ϵ using the δ-estimation function causes the δ-estimation function to generate an estimated privacy breach parameter that is within a tolerance threshold of a target privacy breach parameter δ.

6. The method of claim 5, wherein the current noise multiplier is selected using a bisection algorithm.

7. The method of claim 1, wherein determining the current utility metric for the current correlation matrix based at least in part on the current noise multiplier comprises:
determining the current utility metric for the current correlation matrix as:
$$σ \cdot \vert {A}^{- 1} C \vert$$
wherein σ is the current noise multiplier, A is an all-ones lower-triangular matrix, C is the current correlation matrix, and |·| is a norm operation.

8. The method of claim 1, wherein determining gradients of the current utility metric with respect to the current correlation matrix comprises:
determining gradients, with respect to the current correlation matrix, of a δ-estimation function that is configured to process an input correlation matrix, an input noise multiplier, and an input privacy budget parameter to generate a Monte Carlo estimate of a corresponding privacy breach parameter; and
determining the gradients of the current utility metric based at least in part on the gradients of the δ-estimation function.

9. The method of claim 1, wherein determining gradients of the current utility metric with respect to the current correlation matrix comprises:
determining gradients, with respect to the current noise multiplier, of a δ-estimation function that is configured to process an input correlation matrix, an input noise multiplier, and an input privacy budget parameter to generate a Monte Carlo estimate of a corresponding privacy breach parameter; and
determining the gradients of the current utility metric based at least in part on the gradients of the δ-estimation function.

10. The method of claim 1, wherein determining gradients of the current utility metric with respect to the current correlation matrix comprises:
determining the gradients of the current utility metric as:
$$σ \cdot \frac{\partial \vert {A}^{- 1} C \vert}{\partial C} - \frac{\vert {A}^{- 1} C \vert ( \frac{\partial \hat{δ}}{\partial C} )}{\frac{\partial \hat{δ}}{\partial σ}}$$
wherein σ is the current noise multiplier, A is an all-ones lower-triangular matrix, C is the current correlation matrix, |·| is a norm operation, ∝ is a partial derivative operator, and \hat{δ} is a δ-estimation function.

11. The method of claim 1, wherein during the iterative updates to the current correlation matrix over the plurality of optimization iterations, the current correlation matrix is constrained to remain in a lower-dimensional subspace of a space of possible correlation matrices.

12. The method of claim 11, wherein the lower-dimensional subspace comprises a space of Toeplitz matrices.

13. The method of claim 11, wherein the lower-dimensional subspace comprises a space of block lower triangular matrices.

14. The method of claim 11, wherein the lower-dimensional subspace comprises a space of lower triangular matrices.

15. The method of claim 1, wherein updating the current correlation matrix using the gradients of the current utility metric comprises:
updating the current correlation matrix using the gradients of the current utility metric using a gradient descent optimization technique.

16. The method of claim 1, wherein the neural network is configured to perform an image processing task comprising processing an input image to generate a prediction characterizing the input image; or
wherein the neural network is configured to perform an audio processing task comprising processing input audio data to generate a prediction characterizing the input audio data; or
wherein the neural network is configured to perform a video processing task comprising processing input video data to generate a prediction characterizing the input video data.

17. The method of claim 1, further comprising, after training the neural network:
receiving a network input to the neural network; and
processing the network input using the trained neural network to generate a corresponding network output; and
providing the network output generated by the neural network.

18. A system comprising:
one or more computers; and
one or more storage devices communicatively coupled to the one or more computers, wherein the one or more storage devices store instructions that, when executed by the one or more computers, cause the one or more computers to perform operations, the operations comprising:
training the neural network on a set of training examples to perform a machine learning task, the training comprising, at each of a plurality of training iterations:
determining gradients of an objective function with respect to a set of neural network parameters of the neural network;
generating a plurality of noise values for modifying the gradients of the objective function, comprising:
stochastically sampling a plurality of initial noise values from a noise distribution that is parametrized by a noise multiplier; and
generating the noise values by applying a correlation matrix to the plurality of initial noise values;
generating noisy gradients by combining the plurality of noise values with the gradients of the objective function; and
updating the set of neural network parameters of the neural network using the noisy gradients;
wherein the correlation matrix used during the training of the neural network is determined by performing operations comprising:
iteratively updating a current correlation matrix over a plurality of optimization iterations to optimize a utility metric, comprising, at each optimization iteration:
determining a current noise multiplier that, if used in conjunction with the current correlation matrix during the training of the neural network, is predicted to cause the trained neural network to satisfy a data security criterion;
determining a current utility metric for the current correlation matrix based at least in part on the current noise multiplier;
determining gradients of the current utility metric with respect to the current correlation matrix; and
updating the current correlation matrix using the gradients of the current utility metric.

19. One or more non-transitory computer storage media storing instructions that when executed by one or more computers cause the one or more computers to perform operations, the operations comprising:
training the neural network on a set of training examples to perform a machine learning task, the training comprising, at each of a plurality of training iterations:
determining gradients of an objective function with respect to a set of neural network parameters of the neural network;
generating a plurality of noise values for modifying the gradients of the objective function, comprising:
stochastically sampling a plurality of initial noise values from a noise distribution that is parametrized by a noise multiplier; and
generating the noise values by applying a correlation matrix to the plurality of initial noise values;
generating noisy gradients by combining the plurality of noise values with the gradients of the objective function; and
updating the set of neural network parameters of the neural network using the noisy gradients;
wherein the correlation matrix used during the training of the neural network is determined by performing operations comprising:
iteratively updating a current correlation matrix over a plurality of optimization iterations to optimize a utility metric, comprising, at each optimization iteration:
determining a current noise multiplier that, if used in conjunction with the current correlation matrix during the training of the neural network, is predicted to cause the trained neural network to satisfy a data security criterion;
determining a current utility metric for the current correlation matrix based at least in part on the current noise multiplier;
determining gradients of the current utility metric with respect to the current correlation matrix; and
updating the current correlation matrix using the gradients of the current utility metric.

20. The one or more non-transitory computer storage media storing instructions of claim 19, wherein the data security criterion is an (ϵ, δ)-differential privacy (DP) criterion, wherein ϵ is a target privacy budget parameter defining a bound on a privacy loss, and δ is a target privacy breach parameter defining a bound on a probability of a privacy loss exceeding the privacy budget parameter ϵ.
